(19) United States
(12) Patent Application Publication
(10) Pub. No.: US 2005/0022534 A1
(43) Pub. Date: Feb. 3, 2005

(54) Method and means for cooling fuel oil check valves in dual fuel gas turbines

(76) Inventor: Thomas A. Moody, Bellevue, WA (US)

Correspondence Address: THOMTE, MAZOUR & NIEBERGALL, L.L.C., 2120 S. 72ND STREET, SUITE 1111, OMAHA, NE, 68124, US

(21) Appl. No.: 10/698,139

(22) Filed: Nov. 1, 2003

Related U.S. Application Data
(63) Continuation-in-part of application No. 10/629,981, filed on Jul. 30, 2003.

(51) Int. Cl. F02C 1/00

(52) U.S. Cl. 60/772

(57) ABSTRACT

A method and means for cooling the fuel oil check valves of a dual fuel gas turbine wherein cooling air is blown into an enclosure housing the gas turbine with the cooling air being directed onto the fuel oil check valves to prevent the coking the of same during the times that the gas turbine is fueled with a gaseous fuel.

### CROSS-REFERENCE TO RELATED APPLICATION

This is a continuation-in-part application of Petitioner's earlier application Ser. No. 10/629,981 filed Jul. 30, 2003, entitled METHOD AND MEANS FOR COOLING FUEL OIL CHECK VALVES IN DUAL FUEL GAS TURBINES.

### BACKGROUND OF THE INVENTION

1. Field of the Invention

This invention relates to a method and means for cooling fuel oil check valves in dual fuel gas turbines and more particularly to a method and means for cooling the fuel oil check valves in dual fuel gas turbines to prevent the check valves from coking and becoming unreliable and/or inoperable.

2. Description of the Related Art

In a dual fuel gas turbine, the combustors thereof burn either liquid fuel oil or gaseous fuel in compressed air. The primary reason for a dual fuel gas turbine is that at certain times, the gas fuel price may be extremely high while the price of diesel fuel may be somewhat lower. In those cases, it is desirable to enable the gas turbine to be operated or fueled with liquid fuel such as number two diesel fuel oil. In some dual fuel gas turbines, a check valve is normally imposed in the fuel oil line with that check valve being closed when the turbine is being fueled with gaseous fuel and which is open when the gas turbine is fueled with liquid fuel such as number two diesel fuel. When the gas turbine is being operated or fueled with gaseous fuel, the oil in the check valve, which is in close proximity to the combustor of the gas turbine, is subjected to extremely high temperatures which sometimes causes the residual oil therein to coke or cake, thereby rendering the check valve unreliable or inoperative. This is especially true in the General Electric 7FA combustion turbines.

### SUMMARY OF THE INVENTION

A method and means is described for solving the problem of fuel oil check valve coking in dual fuel gas turbines. The invention herein is used in combination with a dual fuel gas turbine enclosed within an enclosure which is negatively pressurized. One or more ambient air inlets are formed in the walls of the enclosure which are in communication with a manifold or ambient air conduits which extend from the air inlets to the fuel oil check valves. The negative pressure within the enclosure causes ambient air to be drawn inwardly through the ambient air inlets, through the air conduits and to be directed onto the fuel oil check valves to cool the same, thereby preventing coking of the check valves when the gas turbine is being fueled by gaseous fuel.

A modified form of the invention is also disclosed wherein cooling air is supplied to the check valves by means of a blower rather than relying upon the negative pressure within the enclosure to draw the ambient air into the manifold.

It is therefore a principal object of the invention to provide a means for cooling the fuel oil check valves in a dual fuel gas turbine to prevent the coking thereof.

A further object of the invention is to provide a method and means for cooling the fuel oil check valves of a dual fuel gas turbine which does not require any modification of the gas turbine itself.

Yet another object of the invention is to provide a method and means for cooling the fuel oil check valves of a dual fuel gas turbine through the use of ambient air.

Still another object of the invention is to provide a method and means for cooling the fuel oil check valves of a dual fuel gas turbine through the use of ambient air and which includes means for closing the ambient air inlets by means of a fire damper door.

Still another object of the invention is to provide a method and means for cooling the fuel oil check valves of a dual fuel gas turbine to increase the reliability of the fuel oil check valves.

These and other objects will be apparent to those skilled in the art.

### BRIEF DESCRIPTION OF THE DRAWINGS

FIG. 1 is a partial perspective view of an enclosure which has a dual fuel gas turbine positioned therein;

FIG. 2 is a partial perspective view of a gas turbine having the ambient air cooling means of this invention associated therewith;

FIG. 3 is an end view of the structure seen in FIG. 2;

FIG. 4 is a partial perspective view of an air inlet for the ambient air system;

FIG. 5 is a perspective view as seen from the inner side of the structure of FIG. 4;

FIG. 6 is a partial sectional view illustrating the manner in which cool ambient air is passed over the fuel oil check valve of a combustor;

FIG. 7 is a partial perspective view of illustrating the manner in which the ambient air conduits are connected to the ambient air inlets; and

FIG. 8 is an exploded perspective view of a modified form of the invention.

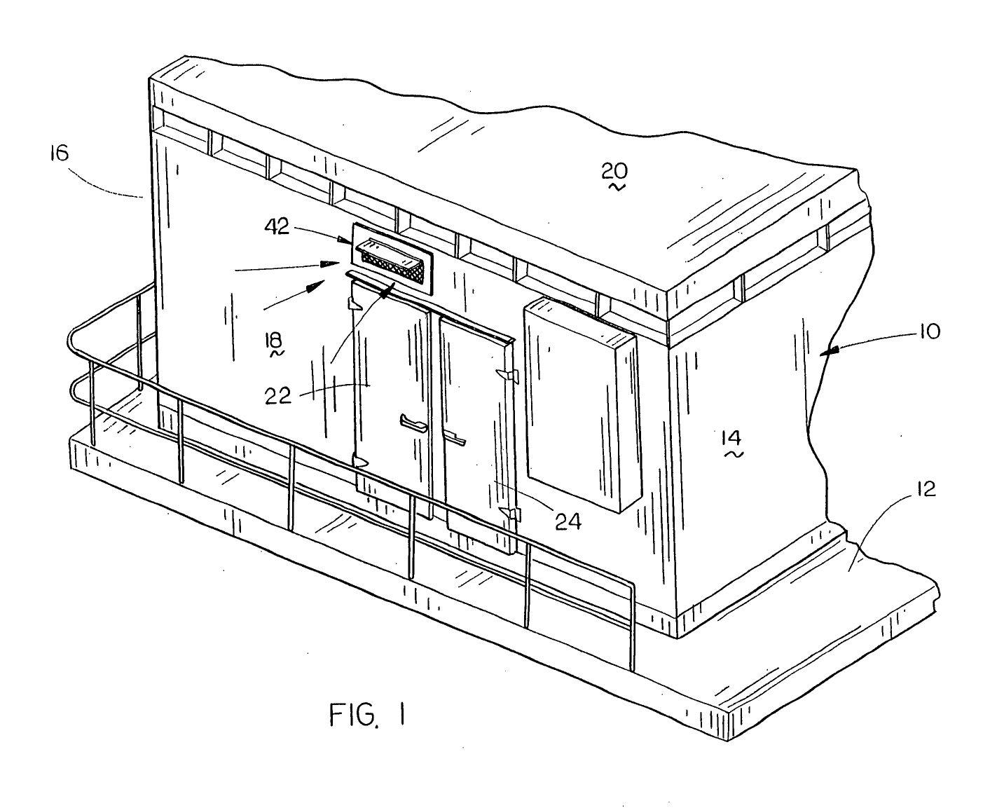

### DETAILED DESCRIPTION OF THE INVENTION

Referring to the drawings, the numeral 10 refers generally to a conventional negatively pressurized enclosure which is positioned upon a slab or other suitable support 12. Enclosure 10 includes opposite end walls 14 and 16 and opposite side walls 18 and 18′. Roof 20 extends over the enclosure in conventional fashion to seal the enclosure. Enclosure 10 includes a pair of access doors 22 and 24. Normally, the enclosure 10 will be negatively pressurized by means of an exhaust fan or blower which exhausts the hot air from within the enclosure 10 in a greater amount than that which enters the interior of the enclosure by way of a conventional air inlet.

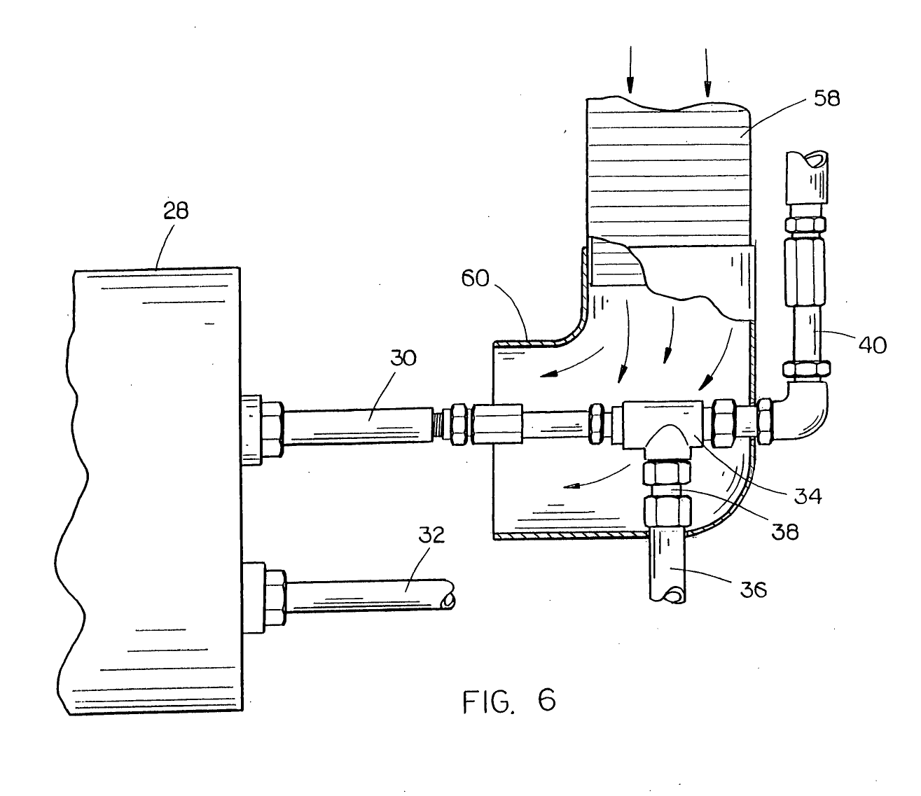

The enclosure 10 houses a conventional dual fuel gas turbine which is referred to generally by the reference numeral 26 and which includes a plurality of circumferentially arranged combustors 28 of conventional design. Each of the combustors 28 has a fuel oil line 30 in communication therewith, as viewed in FIG. 6. Each of the combustors 28 also has a gas fuel line 32 associated therewith which is connected to a source of gaseous fuel in conventional fashion. The fuel oil line 30 is fluidly connected to a “T” fitting 34, as seen in FIG. 6. A fuel oil supply line 36 is connected to the “T” fitting 34, as seen in FIG. 6. A fuel oil check valve 38 is imposed in fuel oil supply line 36. The “T” fitting 34 is also connected to a purge air line 40.

When the gas turbine 26 is being fueled with a gaseous fuel through the gas fuel line 32, the check valve 38 is closed so that the combustor 28 is only supplied with the gaseous fuel. When the turbine 26 is being fueled by the gaseous fuel, an extremely large amount of heat is generated by the turbine and the temperature adjacent the combustor 28 can sometimes reach approximately 300° F., especially those uppermost combustors 28. In normal conditions, the check valve 38 is subjected to extreme heat adjacent the turbine 26 which may cause the fuel oil therein to coke or cake which may interfere with the operation of the check valve 38 when the turbine 26 is to be fueled by fuel oil such as number two diesel fuel. The combustors 28 at the upper portion of the turbine 26 are the combustors which are exposed to the highest temperatures and it is the uppermost check valves 38 that tend to coke. Thus, the instant invention has been provided to prevent the check valves 38 from becoming coked, thereby rendering the same unreliable and/or inoperative.

Preferably, side walls 18 and 18′ are provided with ambient air inlets 42 and 42′, respectively. Inasmuch as air inlets 42 and 42′ are identical, only air inlet 42 will be described in detail. Air inlet 42 comprises a plate 44 having a grill 46 supported thereon. Preferably plate 44 is secured to the exterior surface of side wall 18 by means of screws or the like. A fire damper door 48 is pivotally or hingedly connected at its upper end to the plate 44 at 50 and is movable between open and closed positions with respect to the grill 46. An actuator such as a solenoid 52 is operatively connected to the door 48 for pivotally moving the door 48 between its open and closed positions. Door 48 is normally open to permit ambient air to be drawn inwardly through the grill 46 due to the negative pressure within the enclosure 10. Should a fire occur within the enclosure 10, the actuator 52 will close the door 48 to prevent air from entering the enclosure 10 through the grill 46.

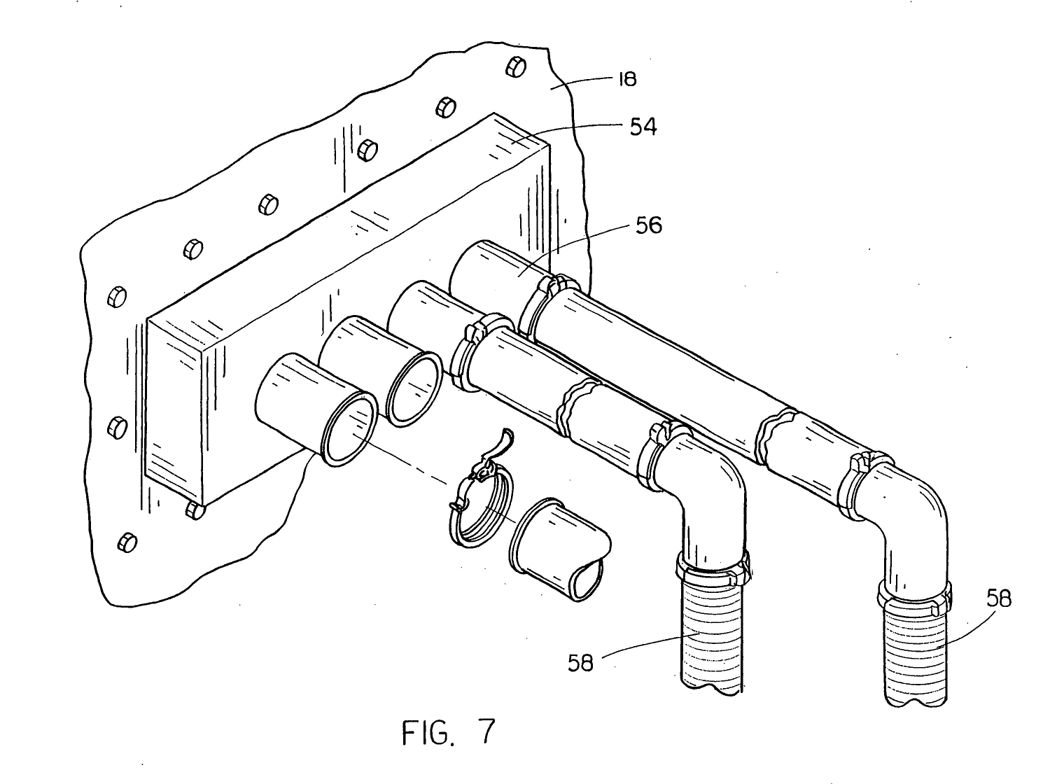

Box 54 is provided on the interior surface of the plate 44 and has a plurality of tubular fittings or pipe stubs 56 extending inwardly therefrom. The inner ends of each of the pipe stubs or fittings 56 are operatively connected to an ambient air conduit 58 by any convenient means, such as illustrated in FIG. 7. The other ends of the ambient air conduits 58 have an elbow 60 secured thereto which forms the discharge end of the conduit 58. The elbow 60 embraces or surrounds the check valve 38, “T” fitting 34 and associated structure, as illustrated in FIG. 6. Although an ambient air conduit 58 could be used for each of the combustors 28, it has been found that only the combustors 28 at the upper end of the turbine 26 need cooling air and for that reason, there is normally no need to supply cooling air to the check valves 38 for each of the combustors 28, but the same could be done if so desired.

During the operation of the turbine 26 with gaseous fuel, the negative pressure within the enclosure 10 will cause ambient air from outside the enclosure 10 to be drawn inwardly through the ambient air inlets 42 and 42′ and through the air conduits 58 with the ambient air flowing over the check valves 38, as illustrated in FIG. 6, thereby cooling the check valves 38 so that the check valves 38 will not coke. The cooler ambient air drawn into the air conduits 58 ensures that the check valves will remain functional.

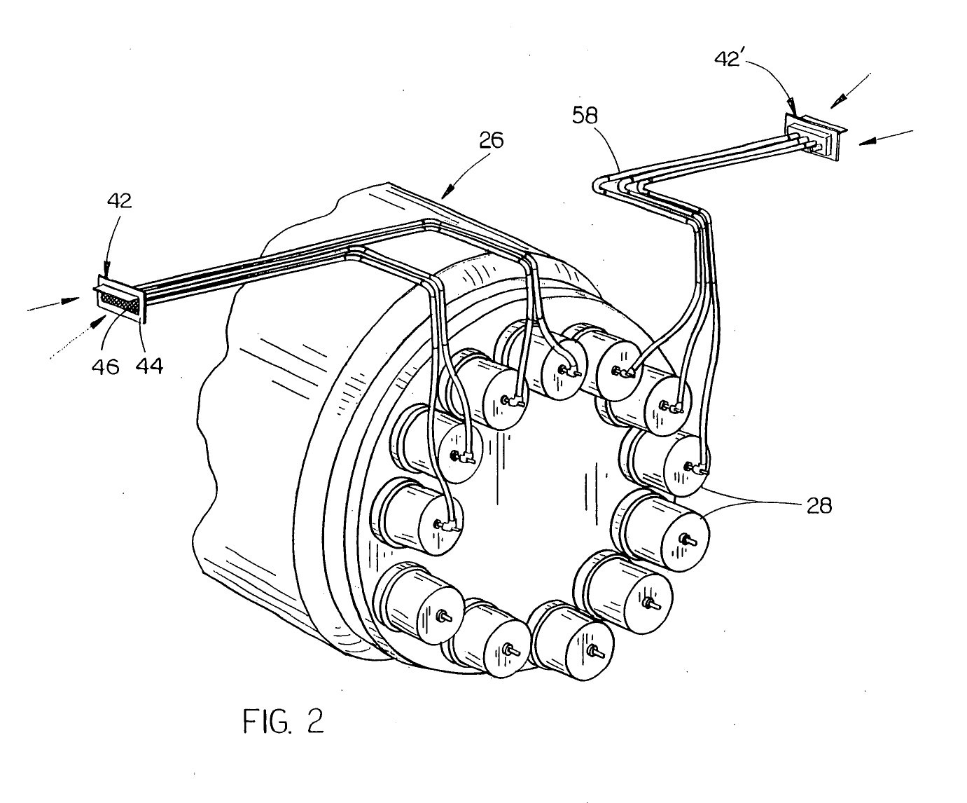

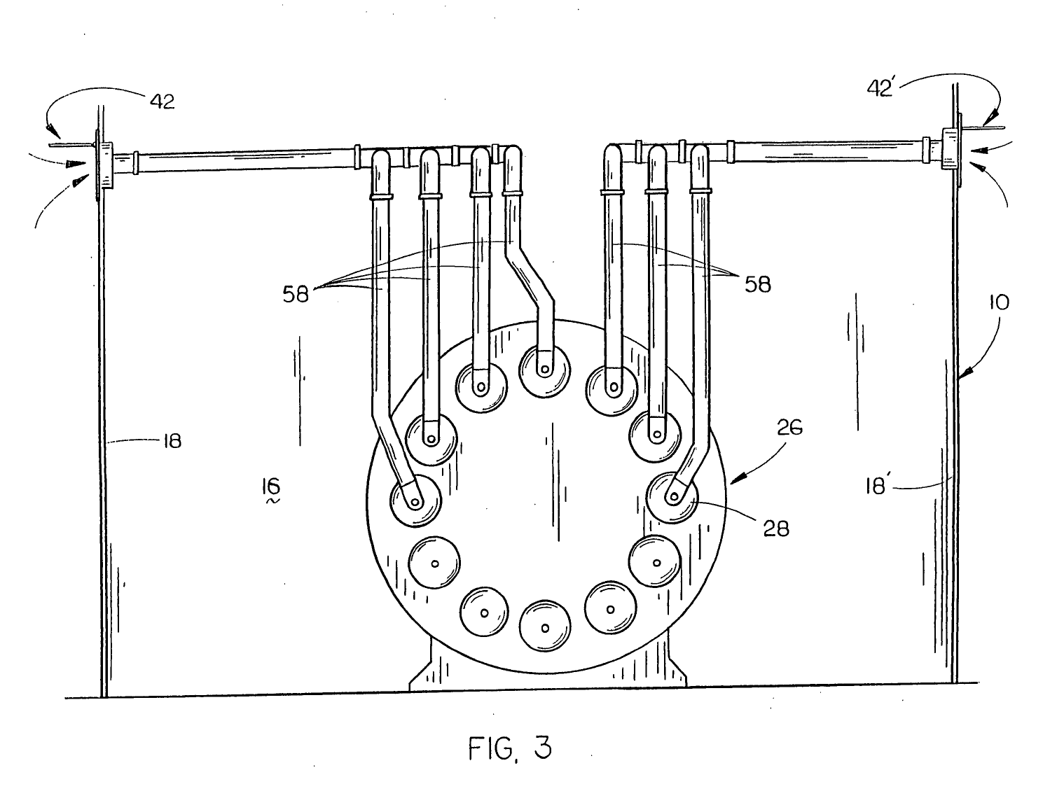

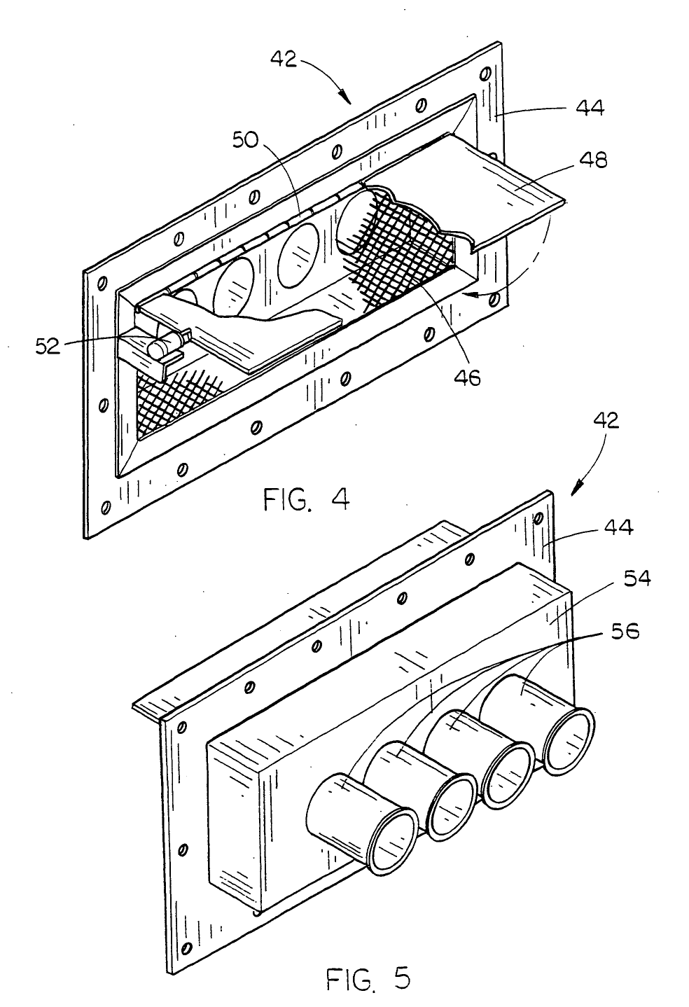

Although a pair of ambient air inlets 42 and 42′ are illustrated in FIG. 2, it is possible that sufficient ambient air may be supplied to the check valves 38 by means of a single ambient air inlet which is connected to a plurality of air conduits 58.

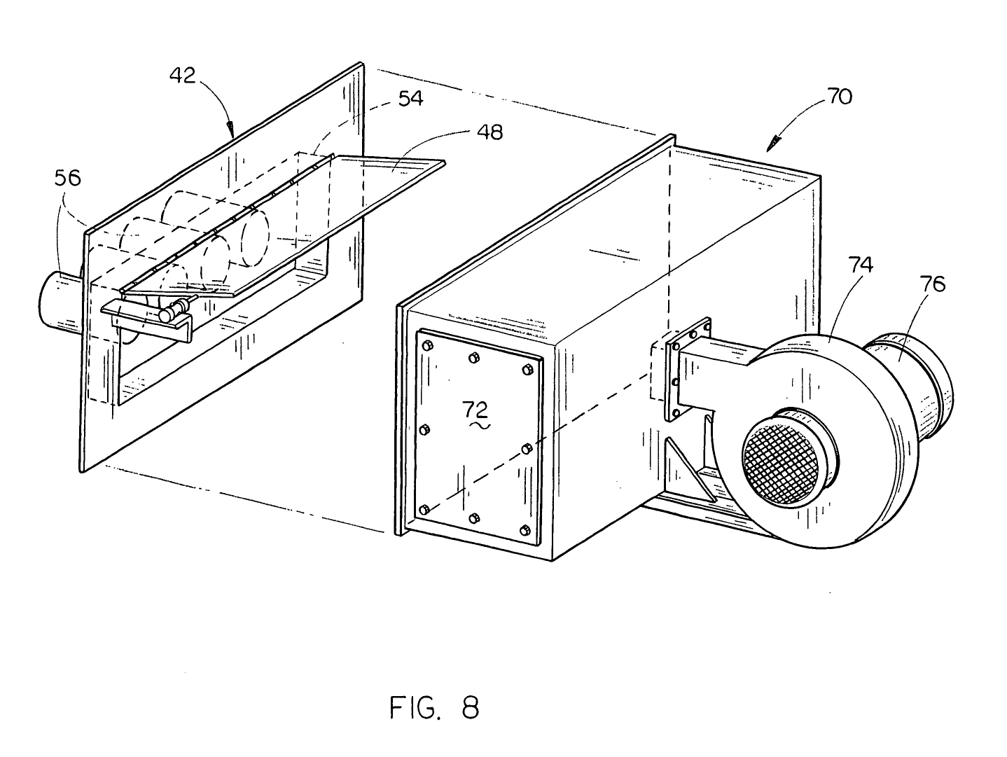

FIG. 8 illustrates a modified form of the invention wherein ambient cooling air is supplied to the manifold by means of a blower rather than relying upon the negative pressure within the enclosure to draw ambient air into the manifold. In FIG. 8, a blower plenum attachment 70 is fit centered over the existing air inlets 42 and 42′ and secured to the damper face. Plenum attachment 70 includes a selectively removable access door 72 at one side thereof for re-setting the damper if necessary. A blower 74 is mounted on the plenum attachment 70, as seen in FIG. 8, and is preferably driven by an electric motor. The intake of blower 74 is in communication with the ambient air outside of the enclosure 10. The discharge side of the blower 74 is in communication with the interior of the box 54 by way of the grill 46 when the door 48 is in its open position. The ambient air is forced through the ambient air conduits 58 so that the ambient air is directed onto the check valves 38 to cool the same so that the check valves 38 will not coke. The cooler ambient air blown into the air conduits 58 ensures that the check valves will remain functional.

Although it is preferred that a pair of air inlets 42 and 42′ be utilized, each of which have an air blower associated therewith, it is possible that only a single air inlet 42 would have an air blower mounted therein with all of the air conduits 58 being in communication with the single air blower.

Thus it can be seen that a novel apparatus and method has been provided for cooling the check valves in the fuel oil lines of a dual fuel gas turbine so that the check valves will remain functional during the periods that the turbine is being fueled with a gaseous fuel and the fuel oil check valves are in the closed position.

It can therefore be seen that the invention accomplishes at least all of its stated objectives.

1. In combination with an enclosure having a pair of end walls, a pair of side walls, and a roof, comprising:
a dual fuel gas turbine in said enclosure;
said gas turbine including a circumferential array of combustors;
each of said combustors having a gaseous fuel line and a liquid fuel line in communication therewith for supplying either gaseous fuel or liquid fuel thereto;
each of said liquid fuel lines having a check valve imposed therein which is open when said gas turbine is being fueled with liquid fuel and which is closed when said gas turbine is being fueled with gaseous fuel;
an air blower having an inlet end and an air discharge end;
said air inlet end of said air blower being in communication with ambient air outside of the enclosure;
and a cooling air conduit having an air inlet end in operative communication with said discharge end of said air blower and an air discharge end which directs ambient air onto at least some of said check valves to cool the same.

2. The combination of claim 1 wherein said cooling air conduit comprises an air manifold which supplies ambient air onto a plurality of check valves.

3. The combination of claim 1 wherein a fire damper door selectively closes said air inlet end of said air conduit.

4. The combination of claim 3 wherein said door is pivotally mounted at said air inlet end and is movable between open and closed positions.

5. The combination of claim 3 wherein said air plenum is mounted over said door to enclose the same and wherein said air blower is mounted on said air plenum so that said discharge end of said air blower is in communication with the interior of said air plenum.

6. The combination of claim 5 wherein said air plenum has an access door provided therein to permit access to said door.

7. The combination of claim 4 wherein a solenoid actuator is connected to said door for pivotally moving said door.

8. The combination of claim 2 wherein said air manifold includes a pair of air inlet ends which are positioned in opposite walls of the enclosure and wherein an air blower is operatively connected to each of said air inlet ends.

9. The combination of claim 8 wherein said air manifold includes a plurality of pipes which extend to said check valves.

10. The combination of claim 9 wherein said air discharges ends of said pipes at least partially surround said check valves.

11. In combination with an enclosure, comprising:
a dual fuel gas turbine in said enclosure;
said gas turbine including a circumferential array of combustors;
each of said combustors having a gaseous fuel line and a liquid fuel line in communication therewith for supplying either gaseous fuel or liquid fuel thereto;
each of said liquid fuel lines having a check valve imposed therein which is open when said gas turbine is being fueled with liquid fuel and which is closed when said gas turbine is being fueled with gaseous fuel;
an air blower having an air inlet end and an air discharge end;
said air inlet end of said air blower being in communication with ambient air outside of the enclosure;
an air manifold positioned within said enclosure and having at least one air inlet end which is in communication with said air discharge end of said air blower;
said air manifold having a plurality of pipes, having air discharge ends, which extend to at least some of said check valves so that ambient air from said air blower is directed onto said check valves to cool the same.

12. The combination of claim 11 wherein the enclosure includes walls and wherein said air manifold includes a pair of air inlet ends positioned in the walls of the enclosure.

13. The combination of claim 11 wherein a fire damper door selectively closes said air inlet end of said air manifold.

14. The combination of claim 12 wherein a fire damper door selectively closes each of said air inlet ends of said air manifold.

15. The combination of claim 14 wherein said air plenum is mounted over said door to enclose the same and wherein said air blower is mounted on said air plenum so that said discharge end of said air blower is in communication with the interior of said air plenum.

16. The combination of claim 15 wherein said air plenum has an access door provided therein to permit access to said door.

17. The combination of claim 11 wherein said air discharge ends of said pipes at least partially surround said check valves.

18. In combination with a dual fuel gas turbine positioned within an enclosure, the gas turbine including a circumferential array of combustors; each of the combustors having a gaseous fuel line and a liquid fuel line in communication therewith for supplying either gaseous fuel or liquid fuel thereto; each of the liquid fuel lines having a check valve imposed therein which is open when the gas turbine is being fueled with liquid fuel and which is closed when the gas turbine is being fueled with gaseous fuel, comprising:
a cooling air conduit having an air inlet end in communication with a source of forced ambient air outside of the enclosure and an air discharge end which directs ambient air onto at least some of the check valves to cool the same.

19. The combination of claim 18 wherein said source of forced ambient air comprises an air blower.

20. The combination of claim 18 wherein said cooling air conduit comprises an air manifold which supplies forced ambient air onto a plurality of check valves.

21. The combination of claim 18 wherein a fire damper door selectively closes said air inlet end of said air conduit.

22. The combination of claim 21 wherein said door is pivotally mounted at said air inlet end and is movable between open and closed positions.

23. The combination of claim 22 wherein a solenoid actuator is connected to said door for pivotally moving said door.

24. The combination of claim 22 wherein said air plenum is mounted over said door to enclose the same and wherein said air blower is mounted on said air plenum so that said discharge end of said air blower is in communication with the interior of said air plenum.

25. The combination of claim 24 wherein said air plenum has an access door provided therein to permit access to said door.

26. The combination of claim 20 wherein said air manifold includes a pair of air inlet ends which are positioned in opposite walls of the enclosure and wherein each of said air inlet ends is in communication with an air blower.

27. The combination of claim 20 wherein said air manifold includes a plurality of pipes which extend to the check valves.

28. The combination of claim 27 wherein said air discharges ends of said pipes at least partially surround the check valves.

29. The method of cooling a liquid fuel check valve of a dual fuel gas turbine positioned in an enclosure, comprising the steps of:
providing an air inlet opening in the enclosure;
providing an air conduit means having air inlet and air discharge ends;
providing a source of forced cooling air;
connecting said air inlet end of said air conduit means to said source of forced cooling air;
positioning said air discharge end of said air conduit means with respect to said check valve so that the cooling air being discharged from said air discharge end of said air conduit means will pass over said check valve to cool the same.

30. The method of claim 29 wherein the source of forced cooling air comprises an air blower.
